(19) United States
(12) Patent Application Publication
(10) Pub. No.: US 2013/0154432 A1
(43) Pub. Date: Jun. 20, 2013

(54) Stator Of An Electric Machine With Voltage Insulation

(71) Applicant: ZF Friedrichshafen AG, Friedrichshafen (DE)

(72) Inventors: Florian LEBERFINGER, Veitshoechheim (DE); Martin HESSDÖRFER, Karlstadt (DE)

(73) Assignee: ZF Friedrichshafen AG, Friedrichshafen (DE)

(21) Appl. No.: 13/713,029

(22) Filed: Dec. 13, 2012

(30) Foreign Application Priority Data
Dec. 15, 2011 (DE) 10 2011 088 658.3

(51) Int. Cl. H02K 3/34

(52) U.S. Cl. CPC H02K 3/345
USPC 310/215

(57) ABSTRACT

A stator of a rotating electric machine includes a circular stator lamination stack having stator teeth projecting radially therefrom and distributed over the circumference and axial slots formed between the teeth. The stator carries a winding of an insulated conductor which is designed for the application of a maximum electric voltage in the low-voltage range up to about 1 kV. The winding is constructed as concentric winding in the form of individual tooth coils, and voltage insulating material is provided inside the slots between the teeth and the winding. To reduce the electric field strength in manufacture-induced voids of the varnish-impregnated or resin-impregnated stator, the voltage insulating material comprises an areally shaped layer of a high-resistance conductive material.

### BACKGROUND OF THE INVENTION

1. Field of the Invention

The invention is directed to a stator of a rotating electric machine provided with voltage insulation.

2. Description of the Related Art

A stator of the type mentioned above is known, for example, from U.S. Pat. No. 6,369,473, the content of which is incorporated herein by reference in its entirety. According to Küchler, “Hochspannungstechnik” (ISBN 978 3 540 21411 3), pages 523 ff., voltage insulating systems of electric machines are commonly designed on the basis of the designated turn-on voltage range. Accordingly, it is typical for electric machines in the low-voltage range up to a maximum voltage of about 1 kV to insert a slot insulation in the form of a sheet-like insulating material into the stator slots, specifically between the stator lamination stack and an insulating wire conductor winding. The stator provided with the winding is then usually completely immersed in insulating varnish or is impregnated with a polyester resin or epoxy resin, the goal being a varnish coat or resin coat having as few voids as possible.

As is well known, a void-free insulation of this kind is very difficult technologically and can only be achieved with a very high expenditure. Further, due to aging processes and external influences such as, e.g., moisture, and mechanical and thermal alternating loads, even insulating systems of optimum construction lead to degradation and to crack formation within the insulating layer. Consequently, undesirably high electric field strengths can occur in these voids during operation of an electric machine and cause at least partial discharges which in turn cause further destruction of the varnish coat or resin coat due to erosion. This problem has long been known in technical circles.

Proceeding from the problem mentioned above, it is an object of the present invention to provide improved voltage insulation for a stator of an electric machine provided for the low-voltage range.

### SUMMARY OF THE INVENTION

The above-mentioned problem is solved in a generic stator of an electric machine by providing voltage insulation in form of an axially shaped layer of a high-resistance conductive material. According to a further aspect of the invention, it is proposed to use a high-resistance conductive material as voltage insulating material in a stator of a rotating electric machine.

Accordingly, the invention provides a stator of a rotating electric machine which comprises a circular stator lamination stack having stator teeth projecting radially therefrom and distributed over the circumference and axial slots formed between the teeth. The stator carries a winding of an insulated conductor which is designed for the application of a maximum electric voltage in the low-voltage range up to about 1 kV. The winding is constructed as a concentric winding in the form of individual tooth coils. Voltage insulating material is provided inside the slots between the teeth and the winding. Alternatively or in addition, the voltage insulation material may also be provided within the slots between the winding and the slot bottom.

According to the invention, the stator is provided with a voltage insulating material which comprises an areally shaped layer of a high-resistance conductive material.

It has turned out that by inserting a highly resistive material such as this between the stator lamination stack and the winding and/or between the winding and the slot bottoms the undesirably high field strengths acting in the voids of stators impregnated with varnish or resin can be effectively reduced. In this way, the risk and the effect of erosion are appreciably mitigated and the durability and reliability of such stators are substantially improved.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The invention will now be described in more detail with reference to the drawings in which:

FIG. 1 is a schematic sectional view of a stator provided with voltage insulating material in accordance with the present invention;

FIG. 2a is a sectional view of voltage insulating material in accordance with the invention provided as a high resistance conductive material on one side of the carrier element; and

FIG. 2b is a sectional view of voltage insulating material in accordance with the invention provided as a high resistance conductive material on two sides of the carrier element.

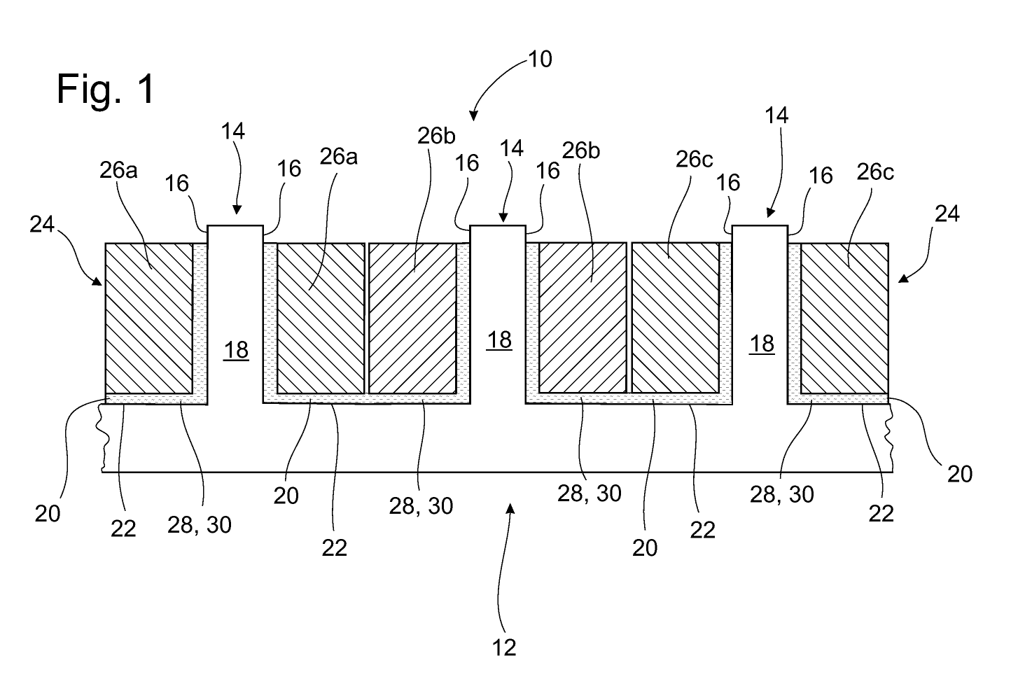

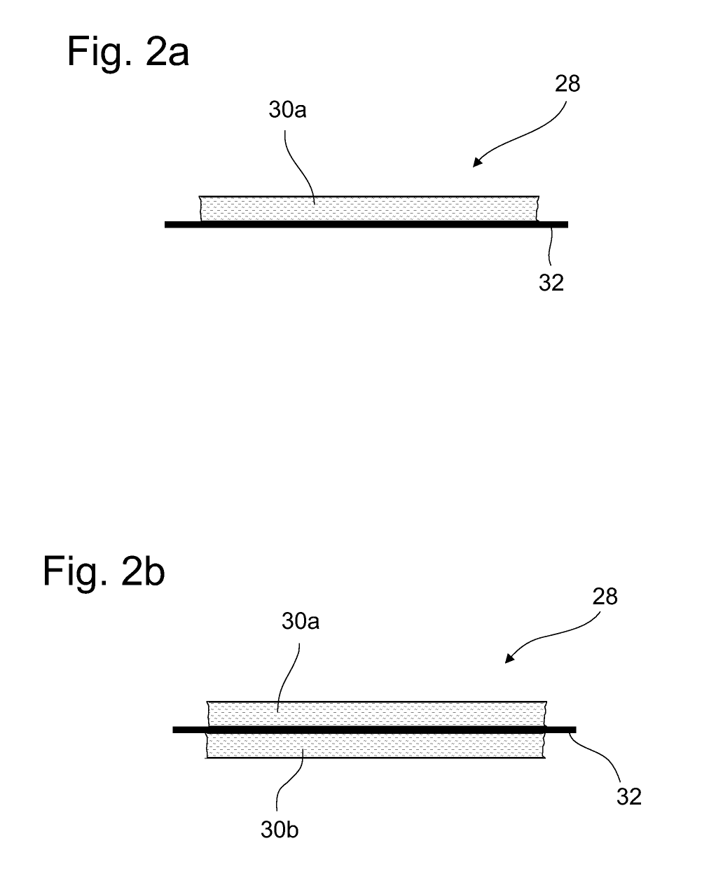

### DETAILED DESCRIPTION OF THE PRESENTLY PREFERRED EMBODIMENTS

According to a particularly preferred element of the invention, the high-resistance conductive material 30 is embodied as conductive varnish 30a, b. This is a varnish whose conductivity is generated by electrically conductive filler materials embedded in the varnish matrix. Conductive varnishes of this kind are known per se in electric machine engineering and were used heretofore exclusively as outer glow-discharge protection in turbo generator engineering in the high-voltage range above about 5 kV as glow discharge protection.

According to an advantageous element, the high-resistance conductive material 30, particularly liquid conductive varnish, is applied to the stator lamination stack 12 of the stator 10 and can accordingly compensate for irregularities at the edge area of the sheet stack, or more precisely the lamination stack, carrying the winding.

Alternatively or in addition to the embodiment mentioned above, it is proposed that the high-resistance conductive material is applied to an electrically insulating, planar carrier element 32. A paper, for example, Nomex aramide paper, a woven material, a formed fabric or a foil is particularly well suited to this purpose. In a combined insulating system of the kind mentioned above, the layer of high-resistance conductive material 30 can advantageously face toward the stator lamination stack and/or toward the winding.

According to another above-mentioned aspect of the invention, the use of a high-resistance conductive material 30 as voltage insulating material in a stator 10 of a rotating electric machine is suggested. In particular, this type of use has turned out to be particularly advantageous in stators 10 which comprise a circular stator lamination stack 12 having stator teeth 14 projecting radially therefrom and distributed over the circumference and axial slots 20 formed between the teeth 14, wherein the stator 10 carries a winding 24 of an insulated conductor which is designed for application of a maximum electric voltage in the low-voltage range up to about 1 kV, and wherein the winding is formed as a concentric winding in the form of individual tooth coils 26a-c. The voltage insulating material 28 is provided inside the slots 20, more precisely between the teeth 14 and the winding 24, and possibly also outside the slots, i.e., at the front sides 18 of the stator 10 as planar layer.

The invention can easily be realized by a person skilled in the art in the manner described in the following at a stator 10 of a rotating electric machine which is provided for application of a maximum electric voltage in the low-voltage range up to about 1 kV. This stator 10 is first constructed in a manner known per se in that it comprises a circular stator lamination stack 12 having stator teeth 14 projecting radially therefrom and distributed over the circumference and axial slots 20 formed between the teeth 14. Before arranging the winding 24, which is designed as a individual tooth winding 26a-c, a liquid conductive varnish serving as voltage insulating material 28 is applied to the flanks 16 of the teeth 14 facing in circumferential direction and possibly also to the front sides 18 of the teeth. Alternatively or in addition to this, a slot insulation paper 32 is inserted into the stator slots 20 as carrier element, a conductive varnish 30 being applied to one or both sides of this slot insulation paper 32. The specific electrical resistance of the conductive varnish 30 can be determined by trial and error and optimized for the intended application based on simple experiments. Generally, standard conductive varnishes with a sheet resistance in the range of about 0.02 to 1 ohm are suitable.

In a further step, the stator winding 24 is wound on the stator teeth 14 in the form of individual tooth coils 26a-c or, in case of prefabricated coils, is attached to the stator teeth. The carrier element 32 can also be combined with the coils to form a constructional unit already before arranging the winding on the stator teeth. In this case, without exclusivity, the winding body described in U.S. Pat. No. 7,732,968 which is incorporated herein by reference in its entirety can preferably be used. Slots for receiving a slot insulation paper are already formed at these winding bodies. When the winding or the entire stator is impregnated in a varnish or a resin, manufacture-induced voids may remain. The high-resistance electrically conductive material, in this case the conductive varnish, ensures a decrease in the electric field strength in the voids during operation of the electric machine so that the risk of destruction of the insulating layer is reduced.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

We claim:

1. A stator of a rotating electric machine comprising:
a circular stator lamination stack (12) having stator teeth (14) projecting radially therefrom and distributed over the circumference thereof; axial slots (20) formed between said stator teeth (14);
a winding (24) of an insulated conductor carried by said stator and designed for the application of a maximum electric voltage in the low-voltage range up to about 1 kV, said winding (24) constructed as concentric winding (24) in the form of individual tooth coils (26a-c);
voltage insulating material (28) provided inside said slots (26) between at least one of said teeth and said winding and said winding and said slot bottom (22), said voltage insulating material comprising an areally shaped layer of a high-resistance conductive material (30).

2. The stator according to claim 1, wherein said high-resistance conductive material (30) is a conductive varnish (30a, b).

3. The stator according to claim 1, wherein said high-resistance conductive material (30) is applied to said stator lamination stack (12).

4. The stator according to one of claim 1, additionally comprising an electrically insulating planar carrier element (32) and wherein said high-resistance conductive material (30) is applied to said electrically insulating, planar carrier element.

5. The stator according to claim 4, wherein said carrier element is formed as one of a paper, a woven material, a formed fabric and a foil.

6. The stator according to claim 5, wherein said layer of high-resistance conductive material (30) faces toward one of said stator lamination stack and toward said winding.

7. The stator according to claim 2, wherein said high-resistance conductive material (30) is applied to said stator lamination stack (12).

8. The stator according to one of claim 2, additionally comprising an electrically insulating planar carrier element (32) and wherein said high-resistance conductive material (30) is applied to said electrically insulating, planar carrier element.

9. The stator according to one of claim 3, additionally comprising an electrically insulating planar carrier element (32) and wherein said high-resistance conductive material (30) is applied to said electrically insulating, planar carrier element.

10. The stator according to claim 5, wherein said layer of high-resistance conductive material is disposed between said slot bottom and said winding.

11. The stator according to claim 5, wherein said layer of high-resistance conductive material is disposed between said stator teeth (14) and said winding (24).
